(19) United States
(12) Patent Application Publication
(10) Pub. No.: US 2018/0035655 A1
(43) Pub. Date: Feb. 8, 2018

(54) FISH MEASURING DEVICE

(71) Applicant: John Charles Callingham, Brisbane (AU)

(72) Inventor: John Charles Callingham, Brisbane (AU)

(21) Appl. No.: 15/553,849

(22) PCT Filed: Feb. 24, 2016
(86) PCT No.: PCT/AU2016/050121

§ 371 Date: Aug. 25, 2017

(30) Foreign Application Priority Data
Feb. 26, 2015 (AU) 2015900680

(51) Int. Cl. A01K 97/00; G01B 3/10

(52) U.S. Cl. CPC A01K 97/00; G01B 3/10; A01K 61/90

(57) ABSTRACT

A fish measuring device is provided including a flexible mat, including measuring indicia for measuring a fish; and a housing, coupled to the flexible mat, for housing the flexible mat. Advantageously, the housing protects the flexible mat from damage. As a result, the flexible mat can provide accurate measurement of fish.

### TECHNICAL FIELD

The present invention relates to a device for measuring fish. In particular, although not exclusively, the present invention relates to a device for measuring a length of a live fish, out of the water, in a catch and release fishing context.

### BACKGROUND ART

Fishing competitions are popular among anglers who compete on catching the largest fish based upon a set of rules. The rules generally define a time in which the competition is held, a particular type of fish, an area and fishing technique.

Traditionally, anglers would kill the fish and take it to a central point for weighing or measuring. However, to ensure sustainability and to avoid overfishing, catch and release fishing competitions have become more popular.

In catch and release fishing competitions, each angler will generally take a photo of each fish caught, in association with a measuring device, prior to releasing the fish. The photos may then be uploaded to a competition website for validation. Measuring mats (also known as “brag mats”) are often used for this purpose as they transportable and are gentle on the fish.

A problem with measuring mats of the prior art is that they are prone to damage. In particular, when thrown around on a boat, portions of the mat may become folded or dented, which later prevents the mat from providing a flat surface on which to measure fish. A measuring mat does not lay flat is generally unable to provide accurate measurements.

FIG. 1 illustrates a measuring mat 100, according to the prior art. The measuring mat 100 has been folded and dented, and as such does not lay flat on the surface in which it is supported. This is clearly illustrated with reference to reference line 105, and measuring tape 110.

Reference line 105 provides a straight reference, which emphasises peaks and troughs formed by the mat when laid on a flat surface. The measuring tape 105 illustrates the inaccuracies of the mat 100 when used in this manner, and how these inaccuracies increase along the length of the mat 100. For example, when measuring a fish that is about 30 cm, the mat is inaccurate by about 1 cm.

As such, the measuring mats of the prior art can cause confusion and uncertainty about a length of a fish, and in the case of minimum fish sizes, can actually result in an illegally sized fish incorrectly being deemed as being of legal size.

A further problem with measuring mats of the prior art is that they are bulky, for example 1m long, to ensure that the same mat may be used to measure fish of various sizes. As a result, the long bulky mat may be impractical for small fish. Furthermore, in order to save space, measuring mats of the prior art are generally folded and rolled, which further damages the mat.

As a result, there is a need for an improved fish measuring device.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a fish measuring device, which may at least partially overcome at least one of the abovementioned disadvantages or provide the consumer with a useful or commercial choice.

With the foregoing in view, the present invention in one form, resides broadly in a fish measuring device including:

a flexible mat, including measuring indicia for measuring a fish; and

a housing, coupled to the flexible mat, for housing the flexible mat.

Advantageously, the housing protects the flexible mat from damage. As a result, the flexible mat may provide accurate measurement of fish. Furthermore, according to certain embodiments, the fish measuring device may be used with part of the mat unrolled, providing a more compact device.

The housing may include a roller, around which the flexible mat may be rolled. The roller may be cylindrical.

The roller may include a retaining member, for retaining an end of the flexible mat. The retaining member may be configured to clamp the end of the flexible mat.

The fish measuring device may include a winder, coupled to the roller, for retracting the mat into the housing. The winder may include gripping elements. The winder may include an extendable arm. In such case, the winder may function in a similar manner to a fishing reel.

The fish measuring device may include a nose plate, against which a “nose” of the fish is placed. The nose plate may be rigid. A first end of the flexible mat may be coupled to the housing, and a second end of the flexible may to the nose plate.

The nose plate may comprise a lower portion, in a same plane as the mat, and a front portion, substantially perpendicular to the lower portion. The housing may be configured to receive the lower portion when in a retracted state.

The housing may be configured to be able to receive the entire flexible mat.

The measuring indicia may increment from the nose plate, along a length of the mat.

The flexible mat may be configured to extend outwardly from the housing through an elongate aperture.

The fish measuring device may be substantially non-metallic. The fish measuring device may be entirely non-metallic. The housing may be formed of impact resistant plastic. The flexible mat may be formed of PVC.

The fish measuring device may include drainage apertures, for enabling fluid to flow through the housing. The drainage apertures may be formed in opposing ends of the housing.

The measuring indicia may comprise a machine readable code. This enables a device, such as a smartphone, potentially together with a server, to automatically determine a length of the fish.

The measuring indicia may comprise a linear code. The measuring indicia may comprise a plurality of quick response codes.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a measuring mat, according to the prior art;

FIG. 2 illustrates an upper perspective view of a retractable fish measuring device, according to an embodiment of the present invention;

FIG. 3 illustrates an end view of the retractable fish measuring device of FIG. 2;

FIG. 4 illustrates a cross sectional view of the retractable fish measuring device of FIG. 2;

FIG. 5 illustrates a top view of the retractable fish measuring device of FIG. 2;

FIG. 6 illustrates an end view of a retractable fish measuring device, according to an embodiment of the present invention;

FIG. 7 illustrates a top view of a retractable fish measuring device 700, according to an alternative embodiment of the present invention;

FIG. 8 illustrates an angling monitoring system 800, according to an embodiment of the present invention; and

FIG. 9 illustrates an angling system 900, according to an embodiment of the present invention.

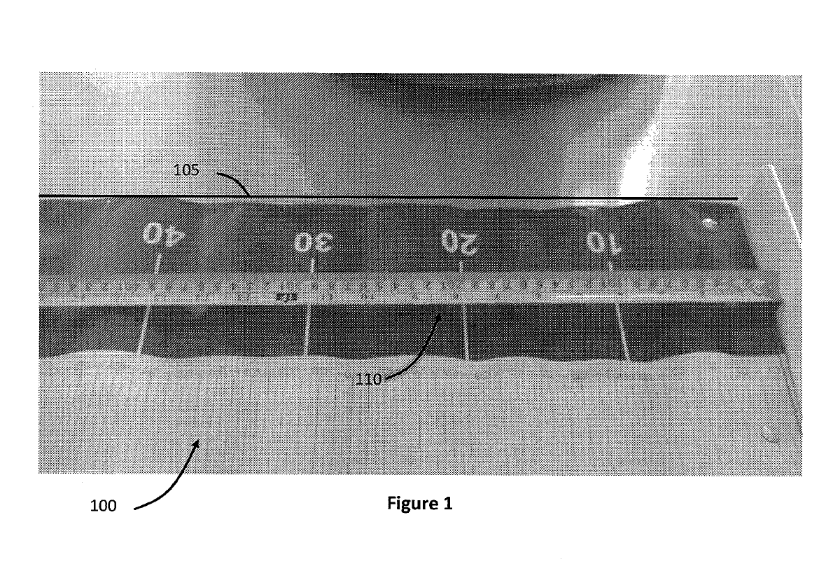

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

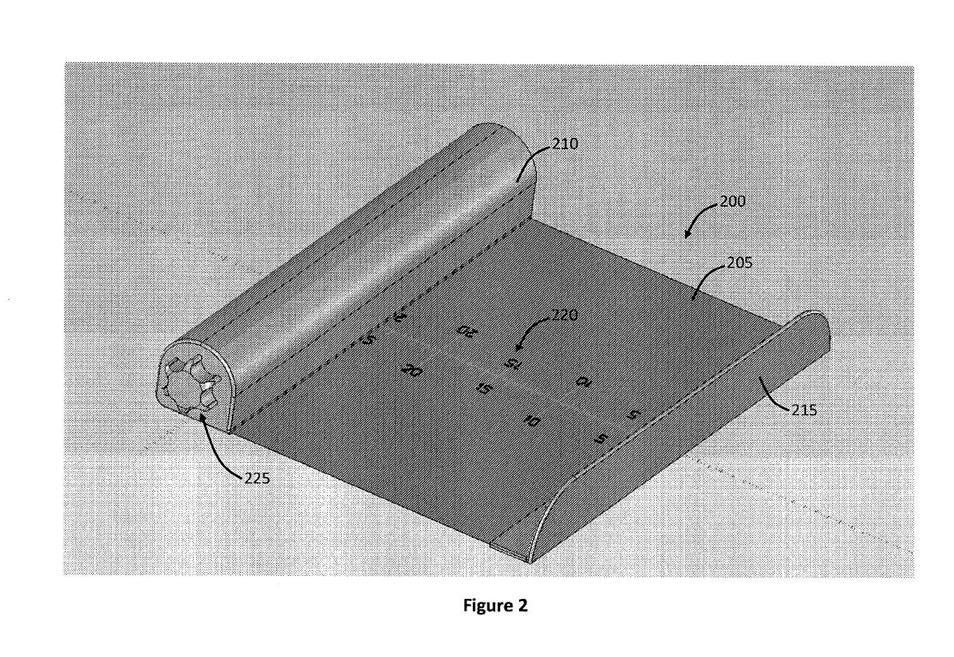

FIG. 2 illustrates an upper perspective view of a retractable fish measuring device 200, according to an embodiment of the present invention. The fish measuring device 200 is particularly suited to measuring fish in a fishing competition, for example on a boat, and is resistant to damage.

The fish measuring device 200 includes a flexible mat 205 and a housing 210, for housing the flexible mat 205 when not in use. In particular, the flexible mat 205 can be unwound from the housing 210 to measure a fish, and later retracted for storage, as described below. The flexible mat 205 extends outwardly from the housing through an elongate aperture 210a.

The fish measuring device 200 includes a rigid nose plate 215, at a distal end of the flexible mat 205, against which a “nose” of the fish is placed. Furthermore, the mat 205 includes measuring indicia 220, along a length of the mat 205, for measuring a length of the fish. FIG. 5 illustrates a top view of the fish measuring device 200 with a fish 505 thereon for measuring.

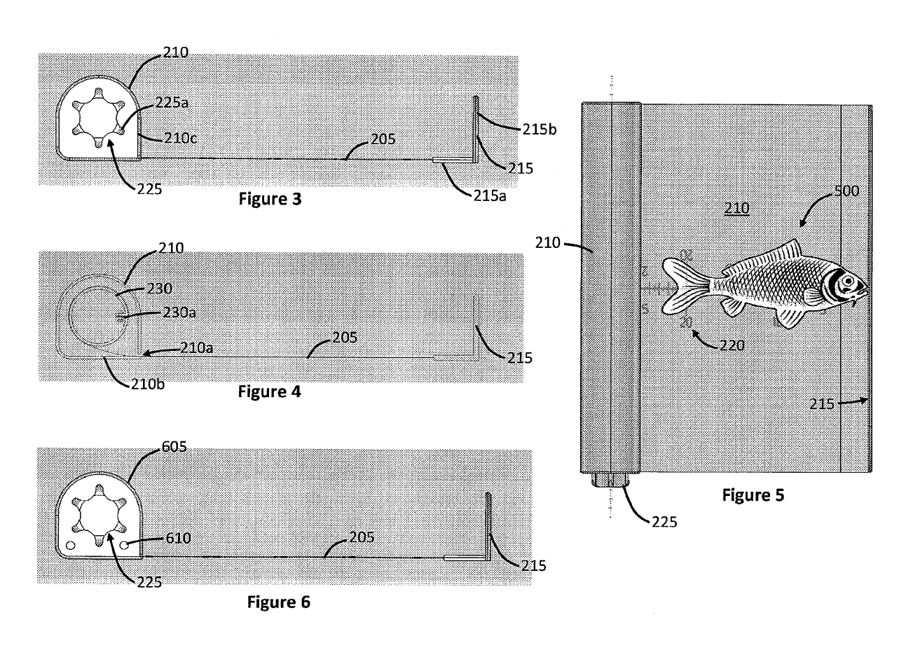

The fish measuring device 200 further includes a winder 225, for unwinding and retracting the mat 205 from and to the fish measuring device 200. As best illustrated with reference to FIG. 3, the winder 225 includes a plurality of knobs 225a, enabling a user to grip and wind the winder 225, even with wet hands.

The housing 210 includes a cylindrical roller 230, coupled to the winder 225, around which the flexible mat 205 rolls, as illustrated in FIG. 4. The roller 230 includes a retaining portion 230a for retaining an end of the flexible mat 205, preventing the flexible mat 205 from separating from the housing 210. In particular, the retaining portion 230a comprises a clamping member that clamps the end of the flexible mat 205.

When not in use, the mat 205 is rolled up around the roller 230, and is thus protected by the housing 210. When wound up, a lower portion 215a of the nose plate 215 enters the housing through the elongate aperture 210a, and rests on a floor 210b of the housing 210. An upper portion 215b of the nose plate 215 then rests against a front 210c of the housing, making the fish measuring device 200 compact and sturdy.

When needed, the mat 205 is unrolled from the roller 230 such that it extends from the housing 210 a desired length, typically a little longer than the fish to be measured. The fish is then placed on top of the unrolled mat 205 with the nose against the nose plate 215. The fish is measured, and the mat is rolled back up onto the roller 230 using the handle 225.

The housing 210, roller 230, nose plate 215 and the handle 225 are advantageously formed of impact resistant plastic. As such, the fish measuring device is resistant to damage, even if dropped or thrown.

The mat 205 may comprise a thin layer of polyvinyl chloride (PVC), on which the indicia 220 are printed.

The fish measuring device 200 is advantageously formed entirely of non-metallic parts. This ensures that the fish measuring device 200 is resistant to corrosion, even if regularly exposed to saltwater.

FIG. 6 illustrates a side view of a retractable fish measuring device 600, according to an alternative embodiment of the present invention.

The retractable fish measuring device 600 is similar to the retractable fish measuring device 200 of FIG. 2, but includes a housing 605 having drainage apertures 610 formed therein.

The drainage apertures 610 are formed on ends of the fish measuring device 600, and enable water to flow through the housing 605 to clean and moisten the mat. For example, the retractable fish measuring device 600 may be immersed in seawater prior to measuring a fish, to provide lubrication to protect the fish when being measured. Similarly, after a fish has been measured, the fish measuring device 600 may be dunked in bucket of water for cleaning the mat 205.

According to an alternative embodiment (not shown), the retractable fish measuring device 200, 600 includes a lug or apertures for receiving a lanyard. As such, the user is able to throw the fish measuring device 200, 600 into water to for rinsing, without risking dropping and losing the device 200, 600.

According to yet an alternative embodiment (also not shown), the winder 225 includes an extendable arm, for assisting in winding up the mat. In particular, the extendable arm extends outwardly from the winder 225 to enable the mat to be wound up in a similar manner to a fishing reel.

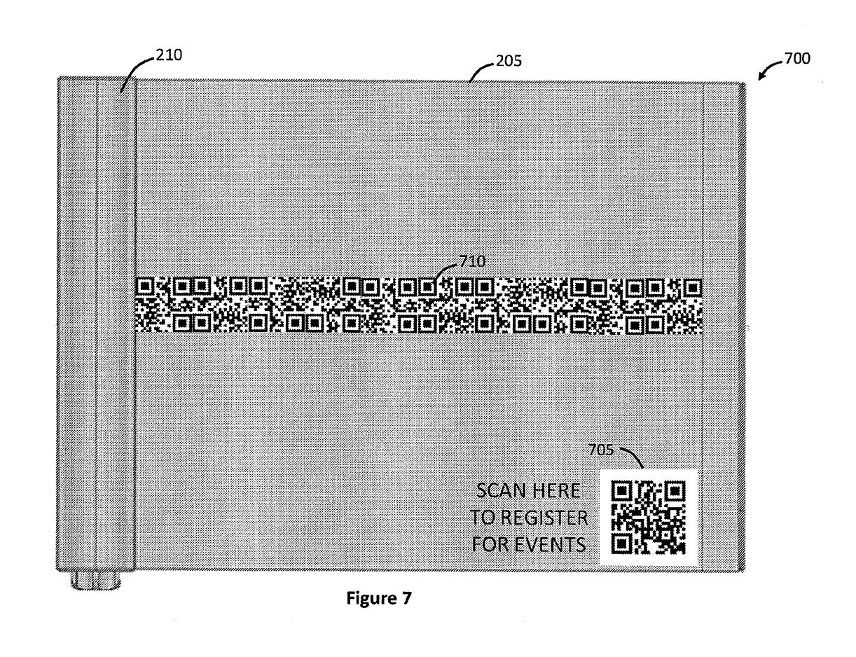

FIG. 7 illustrates a top view of a retractable fish measuring device 700, according to an alternative embodiment of the present invention. The fish measuring device 700 is similar to the fish measuring device 200, but includes a machine readable measuring indicia and a QR code, as discussed below.

The fish measuring device 700 includes a unique mat identifier in the form of a QR code 705, in a lower corner of the mat. The QR code 705 is particularly suited to be read by a computing device, such as a smartphone, and enables the user to efficiently register to events by scanning the code on their smartphone.

The QR code 705 advantageously comprises a Uniform Resource Locator (URL), which comprises a base URL portion, linking to a website, and an identifier portion, uniquely identifying the mat. An example of a suitable URL is “www.softgaff.com/u123232” where www.softgaff.com/ is the base URL portion and u123232 is the identifier portion, uniquely identifying the mat.

Upon entering the URL a first time, the owner of the device 700 is prompted by the server to enter personal details, such as name, address and the like. These personal details are then saved on a server in association with the identifier.

When subsequently entering the URL, the owner's personal details are entered, and list of active events is provided. Examples of events include biggest fish of a particular target species or the largest number of fish caught in a particular time period. The user is then able to register for one of the events.

The fish measuring device further includes a linear code 710, in place of the measuring indicia 220. The linear code 710 enables a computing device to accurately determine a length of the fish by reading the code 710. In particular, the fish is placed above the code 710, in a similar manner to that illustrated above, and thus covers the code along a length of its body. The remaining code that is visible can be used to accurately determine a length of the fish.

According to certain embodiments, the length of the fish is determined by decoding a rightmost complete code, and then by decoding one or more sub codes to the right of the rightmost complete code. As such, the length of the fish may be refined until no more codes or sub-codes can be read.

According to certain embodiments, the linear code 705 is two dimensional. In particular, the linear code 705 may comprise a plurality of QR-like codes in a series. The smallest QR code that can be read may be used to determine a measurement of the fish

By using the linear code, rather than input from the angler, greater accuracy due to less user influence, is provided in measurement of the fish. This is particularly suited for fishing competitions, as outlined below. However, the skilled addressee will readily appreciate that the mat may include both the measuring indicia 220 (enabling the mat to be used outside of competition, e.g. for minimum size measurements) and the linear code 710. In such case, the measuring indicia 220 may, for example, be above and/or below the linear code 710, or form part of the linear code.

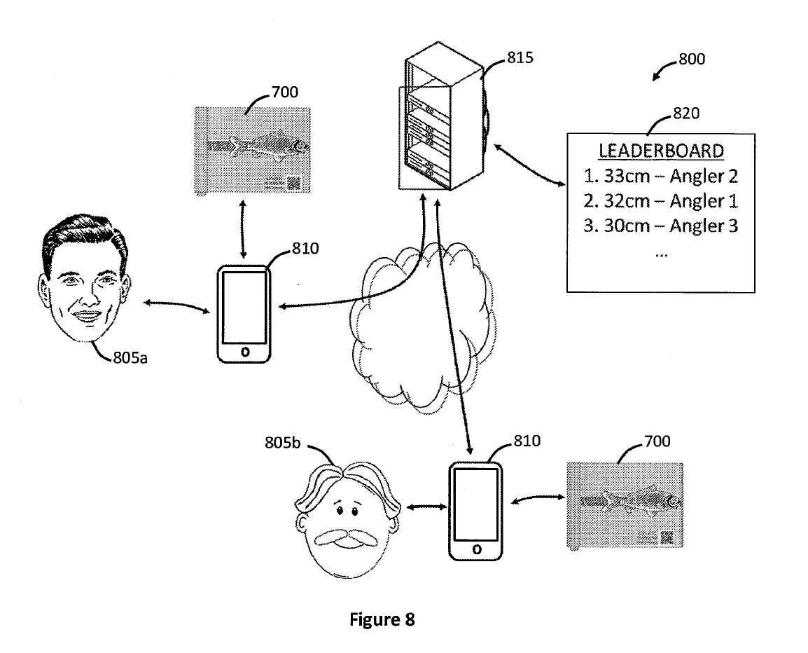

FIG. 8 illustrates an angling monitoring system 800, according to an embodiment of the present invention. The system 800 enables anglers to compete in competitions, as outlined below.

A plurality of anglers 805a, 805b each register to the fishing competition by scanning a code of their respective fish measuring device 700 using a smartphone 810. In particular, the code of the fish measuring device 700 corresponds to a URL which links to a server 815, which monitors entrants and fish data. As discussed above, the code includes an identifier that is unique to the mat and is used to keep a record of details of the anglers 805a, 805b.

When the anglers 805a, 805b catch a fish, they place it on the fish measuring device 700 and take a photo of the fish on the device, which is uploaded to the server 105. The server automatically determines a length of the fish using the linear code 705, as discussed above, and associates the fish with the angler 805a, 805b.

The server 815 maintains a leader board 820 over the largest fish. The leader board 820 may include sub-boards based upon age of the angler (e.g. kids and adults on separate boards), species of fish, and/or location.

According to certain embodiments, the server 815 also confirms that the nose of the fish is flush against the nose plate. If this is not the case, or the photo is otherwise unsuitable, the server 815 may request the angler 805a, 805b to upload a new photo.

Embodiments of the present invention provide a fish measuring device that is robust, and damage resistant. In particular, the housing provides protection for the mat whilst retracted, for example against impact damage or damage from folding of the mat. The code may provide an unbiased means for measuring the length of fish, which makes it particularly suited to competitions.

Furthermore, embodiments of the present invention are easy to use in crowded or space sensitive (such as on a boat), as the user is able to draw out the approximate amount of mat required to measure the fish, without having to unravel the entire mat.

Devices according to embodiments of the present invention may be kept out of the sun and moistened prior to use, which protects the fish, and as a result may increase survival rates of fish returned to the water.

Embodiments of the present invention are easy to clean, and may be immersed in a bucket of water.

According to alternative embodiments (not illustrated), the fish measuring device includes an automatic rewind assembly. The automatic rewind assembly may comprise a plastic clock spring or the like, and is advantageously configured to be resistant to damage and corrosion, even when debris enters the housing.

The measuring indicia may include minimum sizes for certain fish species. This may enable an angler to quickly determine if a fish is of legal length, without having to memorise minimum sizes for different types of fish.

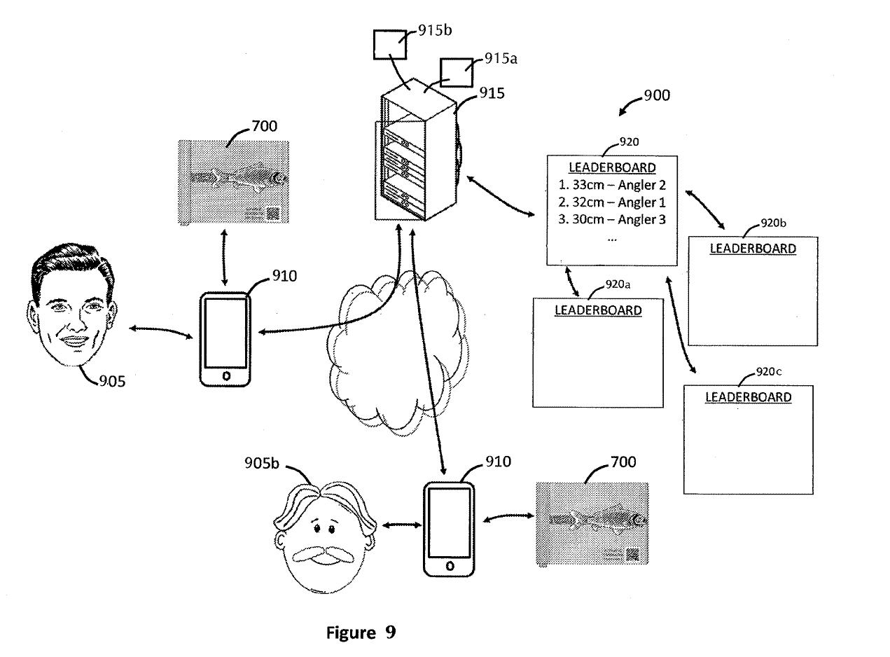

FIG. 9 illustrates an angling system 900, according to an embodiment of the present invention. The system 900 is similar to the system 800, but provides automatic species detection and fish identification, to prevent registration of a single fish multiple times in the same fishing competition.

An angler 905 registers to a fishing competition using a user device 910, and registers catches in the completion by taking photos of his or her catch on a measuring mat 700, as described above, which are uploaded to a server 915.

In addition to identifying a length of the fish, and associating the fish with the angler 905, the server 915 is configured to identify a species of the fish using a species identification module 915a.

The species identification module 915a is configured to determine a plurality of attributes of and relating to the fish, and compare these attributes to attributes of fish species of a set of predefined fish species. A species match is then determined based upon similarities between the attributes of the fish and attributes of each of the fish species.

In particular, the species identification module 915a is configured to determine a silhouette (outline) of the fish, and determine a plurality of attributes from the silhouette. Examples of attributes include an overall shape, a tail shape, a size, a length to height ratio, and the like.

Furthermore, a plurality of attributes are determined based upon the image of the fish, including points on the fish (e.g. illustrating relative eye, fin, mouth and tail portions), and a colour of the fish.

Finally, attributes relating to the fish may be determined, including a location where the fish was caught and a time.

The attributes are then used together to determined a similarity between the fish, and a species of fish.

According to certain embodiments, the set of predefined fish species may be pre-filtered, to remove unlikely candidates. For example, if the caught fish is large, small species of fish that do not exist in that size may be removed from the set prior to species recognition. Similarly, if the fish is caught in a European river, tropical or deep sea fish may be removed from the set of species.

The server 915 maintains a leader board 920 over the largest fish, much like the leader board 820, discussed above. However, the leader board 920 includes sub-boards 920a-920c based upon species.

As such, when the user submits a photo of a bream, for example, the species identification may detect that the species is a bream, and automatically place the fish on a sub-board of the leader board 920 that relates to bream.

According to certain embodiments, the species identification module 915a operates entirely automatically, and without interaction from the angler 905. In other embodiments, the species identification may be used to prompt the angler to confirm the species of the fish (e.g. “Please confirm that the fish is a Snapper”). In some other embodiments, the species identification module 915a may be configured to prompt the user for confirmation of species only when a good match is not found, or where multiple potential matches are found.

According to certain embodiments, confirmation of the species of fish by the angler 905 may be used to improve further recognition of fish species. For example, a dataset of fish of known species may be maintained, and each time a species is added, the dataset may be expanded to suit that species. This may be particularly useful if there are local deviations within a species.

In some cases, the photograph of the fish may be provided to a third party, e.g. an official of the competition, for species review. This is particularly advantageous when the species identification module 915a cannot accurately determine a species of the fish.

While the leader board 920 is illustrated with sub-boards that correspond to different fish species, the skilled addressee will readily appreciate that different sub-boards may relate to multiple fish species. For example, a sub-board may relate to estuarine species, and another sub-board may relate to all species, thus providing an overall leaderboard.

As a fish is registered with the system 900, a fish identification module 915b of the server 915 is configured to determine whether the fish has been previously registered. This is to ensure that anglers do not keep fish live, e.g. in a bait tank, for later registration in the competition, either by the same angler or another angler.

In particular, the fish identification module 915b is configured to generate a plurality of attributes relating to the fish, much like the attributes discussed above in the context of species identification. However, when the fish identification module 915b is comparing the fish to other fish, it need only do this with other fish of the same species, and using attributes that best distinguish different fish inside a species (rather than between species).

Examples of attributes may include, in addition to the attributes discussed above, a patter of scales and spots on the fish, and features such as scars or wounds, retinal and iris patterns.

If the fish identification module 915b identifies a match with a previously registered fish, the entry may be automatically disqualified and a notification that the fish has been previously submitted is provided to the angler.

According to other embodiments, the fish identification module may silently monitor registration of previously registered fish, and provide details of same to a competition organiser. As such, if any patterns of repeated registration of fish are identified, the competition organiser may take action, such as banning the relevant anglers.

The attributes of each caught fish are registered in a biometrics data store 925, and are held there for a predefined period. For example, the biometrics data store 925 may be cleared daily, weekly, or between competitions.

The system 900 provides a simplified registration of fish, in that the angler 905 need not manually enter a species of the fish. The system also provides automated fraud prevention, in that fish are prevented from being registered multiple times, and that anglers are prevented from registered larger fish species as smaller species.

According to certain embodiments, the data captured by anglers may be provided for research. In particular, as anglers 905 are catching and registering fish, valuable information, such as average fish size, average catch size, and the like may be provided to research organisations. This may in turn enable trends or patterns to be identified, potentially as they occur, enabling appropriate action to be taken in a timely fashion.

According to certain embodiments, three dimensional imaging of fish may be used to determine size and weight information of the fish. In particular, a three dimensional model of the fish may be generated from a plurality of images of the fish. The three dimensional model may then be used to estimate a size and weight of the fish.

According to certain embodiments, three dimensional imaging of the fish is performed underwater, alleviating the need to even remove the fish from the water. As an illustrative example, a camera, such as a stereoscopic camera, may be incorporated onto a pole, such that images of the fish may be captured as the fish is near the surface of the water (e.g. on the side of a boat).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A fish measuring device including:
a flexible mat, including measuring indicia for measuring a fish; and
a housing, coupled to the flexible mat, for housing the flexible mat.

2. The fish measuring device of claim 1, wherein the housing includes a roller, around which the flexible mat may be rolled.

3. The fish measuring device of claim 2, wherein the roller is cylindrical.

4. The fish measuring device of claim 2, wherein the roller includes a retaining member, for retaining an end of the flexible mat.

5. The fish measuring device of claim 4, wherein the retaining member is configured to clamp an end of the flexible mat.

6. The fish measuring device of claim 2, further comprising a winder, coupled to the roller, for retracting the mat into the housing.

7. The fish measuring device of claim 6, wherein the winder includes gripping elements.

8. The fish measuring device of claim 6, wherein the winder includes an extendable arm.

9. The fish measuring device of claim 1, further including a nose plate, against which a “nose” of the fish is placed.

10. The fish measuring device of claim 9, wherein the nose plate is rigid.

11. The fish measuring device of claim 9, wherein a first end of the flexible mat is coupled to the housing, and a second end of the flexible mat is coupled to the nose plate.

12. The fish measuring device of claim 9, wherein the nose plate comprises a lower portion, in a same plane as the mat, and a front portion, substantially perpendicular to the lower portion.

13. The fish measuring device of claim 12, wherein the housing is configured to receive the lower portion when in a retracted state.

14. The fish measuring device of claim 1, wherein the housing is configured to receive the entire flexible mat.

15. The fish measuring device of claim 1, wherein the measuring indicia increment from the nose plate, along a length of the mat.

16. The fish measuring device of claim 1, wherein the flexible mat is configured to extend outwardly from the housing through an elongate aperture.

17. The fish measuring device of claim 1, wherein the fish measuring device is substantially non-metallic.

18. The fish measuring device of claim 1, wherein the fish measuring device is entirely non-metallic.

19. The fish measuring device of claim 1, wherein the housing is formed of impact resistant plastic.

20. The fish measuring device of claim 1, wherein the flexible mat is formed of PVC.

21. The fish measuring device of claim 1, wherein the housing includes drainage apertures, for enabling fluid to flow through the housing.

22. The fish measuring device of claim 21, wherein the drainage apertures are formed in opposing ends of the housing.

23. The fish measuring device of claim 1, wherein the measuring indicia comprises a machine readable code.

24. The fish measuring device of claim 23, wherein the measuring indicia comprises a linear code.

25. The fish measuring device of claim 23, wherein the measuring indicia comprises a plurality of quick response codes.
